(19) United States
(12) Patent Application Publication
(10) Pub. No.: US 2016/0290258 A1
(43) Pub. Date: Oct. 6, 2016

(54) METHOD AND SYSTEM FOR REDUCING ENGINE NOX EMISSIONS BY FUEL DILUTION

(71) Applicant: Electro-Motive Diesel, Inc., LaGrange, IL (US)

(72) Inventor: Aaron Foege, Westmont, IL (US)

(73) Assignee: Electro-Motive Diesel, Inc., LaGrange, IL (US)

(21) Appl. No.: 14/678,366

(22) Filed: Apr. 3, 2015

(51) Int. Cl. F02D 41/00; B61C 5/00

(52) U.S. Cl. CPC F02D 41/0027; B61C 5/00

(57) ABSTRACT

An engine may comprise at least one cylinder having a combustion chamber disposed therein, a piston positioned for displacement within the cylinder, and at least one air intake port configured to allow an intake of air into the combustion chamber. The engine may further comprise a fuel injector configured to inject a fuel diluted with an inert substance into the combustion chamber for combustion with the air. The combustion with the air may occur at a lower temperature than a combustion of the fuel with the air when the fuel is undiluted.

### TECHNICAL FIELD

The present disclosure generally relates to combustion engines, and more specifically, to systems and methods for reducing NOₓ emissions from combustion engines by diluting a fuel source, such a natural gas, with an inert substance.

### BACKGROUND

Internal combustion engines (ICEs), such as those used to power automobiles, locomotives, and marine ships, operate by combusting fuel with an oxidizer (such as oxygen in air) to generate hot gaseous products that apply force to an engine component such as a piston, a turbine blade, or a nozzle. The applied force may move the engine component over a distance, thereby providing useful mechanical energy from chemical energy.

However, nitrogen oxides (NOₓ) may be produced as a side reaction between nitrogen and oxygen in the air during fuel combustion in an ICE. The formation of NOₓ from nitrogen and oxygen is an endothermic process (i.e., a heat-absorbing reaction), such that NOₓ production increases with higher combustion temperatures. Combustion temperatures may increase with increasing combustion rates which, in turn, may increase with the rate at which oxygen can diffuse into the fuel. Thus, in engine design, there may be a trade-off between high combustion efficiencies (achieved with higher combustion rates) and low NOₓ emissions (achieved with lower combustion rates). As NOₓ is an air pollutant and may react in the atmosphere to form ozone and acid rain, federal emissions regulations are setting increasingly strict NOₓ emission limits on ICEs. For example, federal emissions regulations have reduced the limit for NOₓ emissions from locomotives from 5.5 gram/brake horsepower-hour (g/bhph) in 2014 to 1.3 g/bhph in 2015.

The use of natural gas as a fuel source in ICEs may be one way to reduce NOₓ emissions. Natural gas, which may consist primarily of methane (CH₄), may combust at a lower temperature than other fuels (e.g., diesel), resulting in reduced NOₓ emissions. The lower temperature combustion of natural gas may attributed to the fact that the methane in natural gas has fewer carbons and produces more heat-absorbing water molecules and less carbon dioxide compared with more carbon-rich fuels such as diesel.

Other technologies to reduce NOₓ emissions include exhaust gas recirculation (EGR) systems as well as complex aftertreatment systems in the exhaust line, such as selective catalytic reduction (SCR) systems. An EGR system may recirculate exhaust gases produced during combustion back to the combustion chamber, thereby diluting oxygen in the combustion chamber to lower combustion rates/temperatures and the production of NOₓ. In addition, the exhaust gases may lower the specific heat of the air mixture in the combustion chamber, resulting in lower bulk temperatures in the combustion chamber. However, drawbacks associated with EGR systems include large architectural changes to the engine, the reintroduction of harmful species (e.g., soot particles, nitric acid, sulfuric acid, etc.) into the combustion chamber, as well as a requirement for large systems to cool and recirculate the exhaust gases back to the combustion chamber. SCR systems use ammonia as a catalyst to reduce NOₓ from ICE exhaust to nitrogen and water. However, like EGR systems, SCR systems may require large system components that may be difficult to package on existing engines.

Another strategy to reduce NOₓ emissions, as described in U.S. Patent Application Publication Number 2013/0206100, involves injecting water into an intake manifold of an ICE to dilute the oxygen content of the intake gases, thereby lowering NOₓ emissions. While effective, additional enhancements are still wanting.

Clearly, there is a need for improved strategies for reducing NOₓ emissions from ICEs, such as natural gas ICEs.

### SUMMARY

In accordance with one aspect of the present disclosure, an engine is disclosed. The engine may comprise at least one cylinder having a combustion chamber disposed therein, a piston positioned for displacement within the cylinder, and at least one air intake port configured to allow an intake of air into the combustion chamber. The engine may further comprise a fuel injector configured to inject a fuel diluted with an inert substance into the combustion chamber for combustion with the air. The combustion with the air may occur at a lower temperature than a combustion of the fuel with the air when the fuel is undiluted.

In accordance with another aspect of the present disclosure, a locomotive is disclosed. The locomotive may comprise a car body and one or more trucks supporting the car body and having wheels configured to engage a track. The locomotive may further comprise an engine that may include at least one cylinder having a combustion chamber disposed therein, a piston positioned for displacement within the cylinder, and at least one air intake port configured to allow an intake of air into the combustion chamber. The engine may further comprise a fuel injector configured to inject a fuel diluted with an inert substance into the combustion chamber for combustion with the air. The combustion with the air may occur at a temperature below about 2200° F.

In accordance with another aspect of the present disclosure, a method for combusting natural gas with air in an engine is disclosed. The engine may include a combustion chamber and a fuel injector. The method may comprise filling the combustion chamber with the air, compressing the air in the combustion chamber, and injecting the natural gas diluted with an inert substance into the combustion chamber with the fuel injector. The method may further comprise combusting the natural gas with the air in the combustion chamber such that the combustion occurs at a lower temperature than a combustion of the natural gas with the air when the natural gas is undiluted.

These and other aspects and features of the present disclosure will be more readily understood when read in conjunction with the accompanying drawings.

### BRIEF DESCRIPTION OF THE DRAWINGS

FIG. 1 is a schematic representation of a locomotive having an internal combustion engine and a fuel delivery system, constructed in accordance with the present disclosure.

FIG. 2 is a side view of the internal combustion engine of FIG. 1 shown in isolation, constructed in accordance with the present disclosure.

FIG. 3 is a series of steps that may be involved in delivering fuel to the engine with the fuel delivery system, in accordance with a method of the present disclosure.

FIG. 4 is schematic representation of a portion of the engine shown in isolation, constructed in accordance with the present disclosure.

FIG. 5 is a cross-sectional view of a dual-fuel injector of the fuel delivery system, constructed in accordance with the present disclosure.

FIG. 6 is a series of steps that may be involved in a combustion cycle of the engine, in accordance with a method of the present disclosure.

FIG. 7 is a schematic representation of an expansion stroke of the combustion cycle of the engine, constructed in accordance with the present disclosure.

FIG. 8 is a schematic representation of a compression stroke of the combustion cycle of the engine, constructed in accordance with the present disclosure.

FIG. 9 is a schematic representation of a fuel injection and combustion stage of the combustion cycle of the engine, constructed in accordance with the present disclosure.

FIG. 10 is a data graph showing a correlation between combustion temperature and percent dilution of liquid nitrogen (LN₂) in a natural gas fuel, in accordance with the present disclosure.

FIG. 11 is a data graph showing a correlation between percent NOₓ and percent dilution of liquid nitrogen (LN₂) in the natural gas fuel, in accordance with the present disclosure.

It should be understood that the drawings are not necessarily drawn to scale and that the disclosed embodiments are sometimes illustrated schematically and in partial views. It is to be further appreciated that the following detailed description is merely exemplary in nature and is not intended to limit the invention or the application and uses thereof. In this regard, it is to be additionally appreciated that the described embodiment is not limited to use with a particular type of engine or type of fuel. Hence, although the present disclosure is, for convenience of explanation, depicted and described as certain illustrative embodiments, it will be appreciated that it can be implemented in various other types of embodiments and in various other systems and environments.

### DETAILED DESCRIPTION

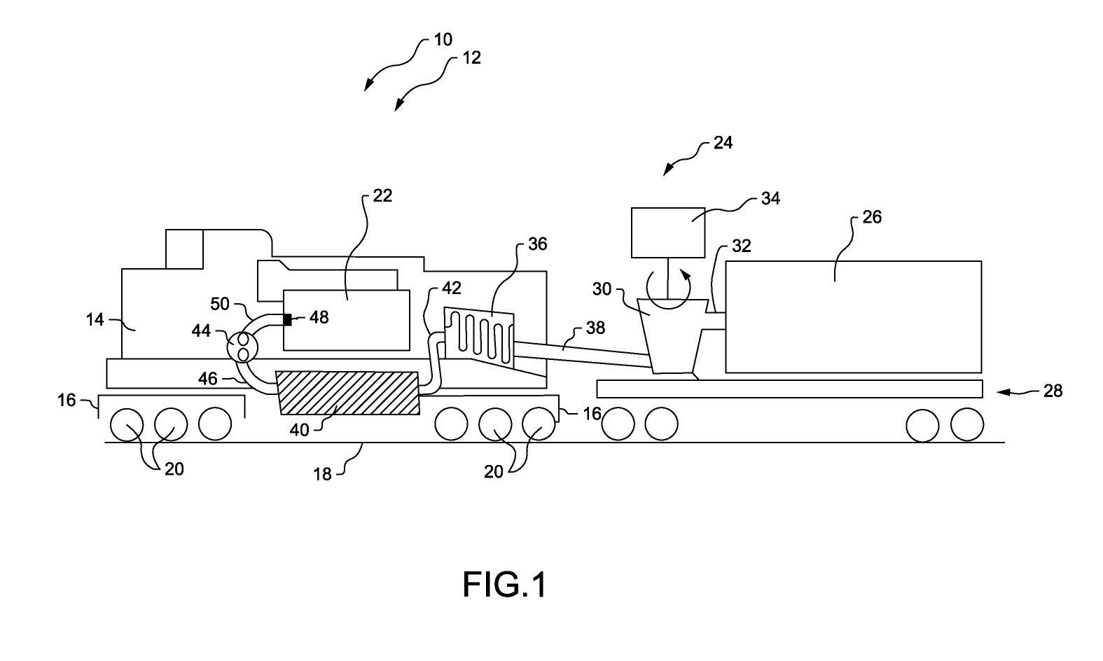

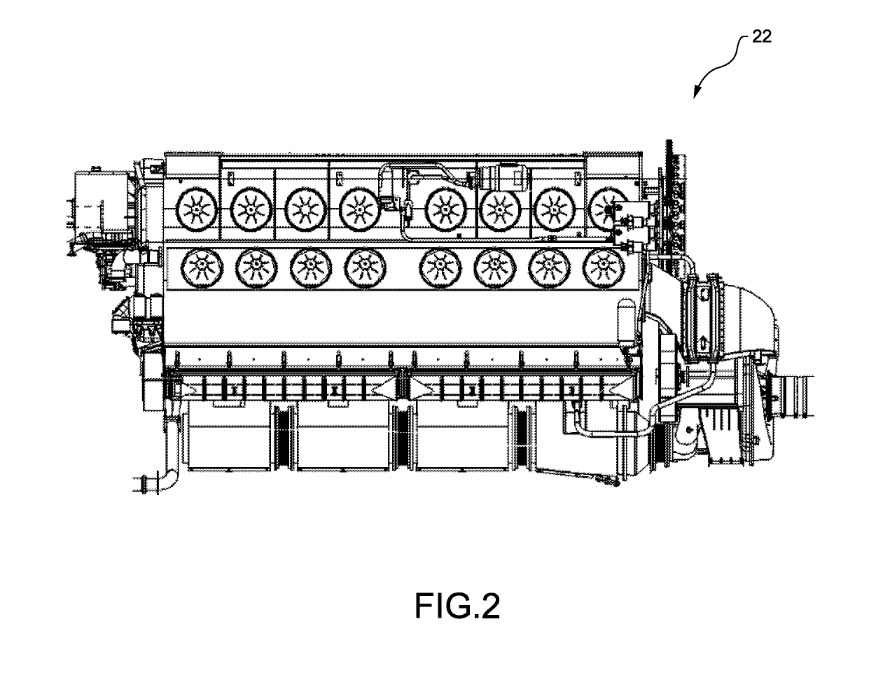

Referring now to the drawings, and with specific reference to FIG. 1, a machine 10 is shown. The machine 10 may be a locomotive 12, or it may be another type of machine such as a marine vehicle (e.g., a boat) or an industrial engine. If the machine 10 is a locomotive 12, it may include a car body 14 supported by trucks 16, and each truck 16 may be configured to engage a track 18 via a plurality of wheels 20. The machine 10 may include an internal combustion engine 22 (also see FIG. 2), as well as a fuel delivery system 24 to supply a fuel to the engine 22. The fuel may be a cryogenic fuel, such as natural gas or methane. As used herein, “cryogenic” means that the substance has a boiling point below about −150° C. and exists as a liquid at temperatures below about −150° C. As described in further detail below, the fuel may be diluted with an inert substance prior to delivery to the engine 22. As used herein, an “inert substance” is a substance that does not participate in combustion reactions in an internal combustion engine. The inert substance may reduce oxygen diffusion into the fuel combustion flame in the engine 22, thereby lowering combustion rates and temperatures in the engine 22 and reducing NOₓ production. Like the cryogenic fuel, the inert substance may be cryogenic and exist as a liquid at temperatures below about −150° C. In this regard, the inert substance may be nitrogen or another suitable cryogenic inert substance.

The engine 22 may be a high pressure direct injection engine in which the fuel is directly delivered to the combustion chamber of the engine 22 at high pressures (above about 5000 pounds per square inch (psi)), allowing combustion of the fuel to occur nearly completely. In addition, the quantity of the fuel injected and the timing of the fuel injection may be similar to that used in a diesel engine, such that combustion rates may approach diesel fuel combustion rates, but with better emission characteristics (reduced NOₓ and particulate matter emissions) due to the use of natural gas or methane as fuel.

The fuel delivery system 24 may include a cryogenic storage tank 26 which may store a mixture of the cryogenic fuel and the inert substance as a cryogenic liquid. For example, the cryogenic liquid may consist of a mixture of liquid natural gas (or liquid methane) and liquid nitrogen. Accordingly, the cryogenic storage tank 26 may maintain the temperature of the cryogenic liquid at a temperature below about −150° C. such that the fuel and the inert substance remain in a liquid state. If the inert substance is nitrogen, the cryogenic fuel may be diluted with between about 2 mass % to about 30 mass % of liquid nitrogen in the cryogenic storage tank 26, although higher or lower dilutions may also be used in some circumstances. If the machine 10 is a locomotive 12, the cryogenic fuel storage 26 may be carried on a car 28 that trails behind the locomotive 12, as shown in FIG. 1. In alternative arrangements, the liquid fuel and liquid nitrogen may be stored in separate cryogenic storage tanks and may be later mixed together with an appropriate mixing device in a controlled manner and in desired relative proportions.

The fuel delivery system 24 may further include a high pressure cryogenic pump 30 in fluid communication with the cryogenic storage tank 26 via one or more conduits 32. The cryogenic pump 30 may pressurize the cryogenic liquid that is drawn out of the cryogenic storage tank 26. The cryogenic pump 30 may have a controller 34, and may pressurize the cryogenic liquid to pressures suitable for high pressure direct injection, such as 6000 psi or greater. Pressurization of the cryogenic liquid with the cryogenic pump 30 may be achieved with significantly less energy than is required to pressurize a comparable gaseous mixture as it requires less energy to pressurize a liquid than a gas. This is one of the advantages of storing the fuel/inert substance mixture as a liquid.

The fuel delivery system 24 may also include a vaporizer 36 in fluid communication with the cryogenic pump 30 via one or more conduits 38. The vaporizer 36 may vaporize the cryogenic liquid from the cryogenic pump 30 to a gaseous mixture of the fuel and the inert substance. In addition, an accumulator 40 may be in fluid communication with the vaporizer 36 via one or more conduits 42 and may store the gaseous mixture after vaporization. Specifically, the accumulator 40 may store small quantities of the gaseous mixture to regulate the difference in fuel supply from the cryogenic pump 30 and the fuel demand of the engine 22. The vaporizer 36 and the accumulator 40 may be carried together or separately on the locomotive 12, as shown in FIG. 1, or on the car 28 trailing behind the locomotive 12. Optionally, the fuel delivery system 24 may also include a fuel conditioning module 44 that may be in fluid communication with the accumulator 40 via one or more conduits 46 and may regulate the pressure of the gaseous mixture from the accumulator 40. In particular, the fuel conditioning module 44 may condition the gaseous mixture by dampening any pressure fluctuations in the gaseous mixture and reducing or normalizing the pressure of the gaseous mixture to a pressure suitable for injection into the engine 22. The fuel conditioning module 44 may also be in fluid communication with a fuel injector 48 via one or more conduits 50 and may deliver the conditioned gaseous mixture to the fuel injector 48 for combustion in the engine 22.

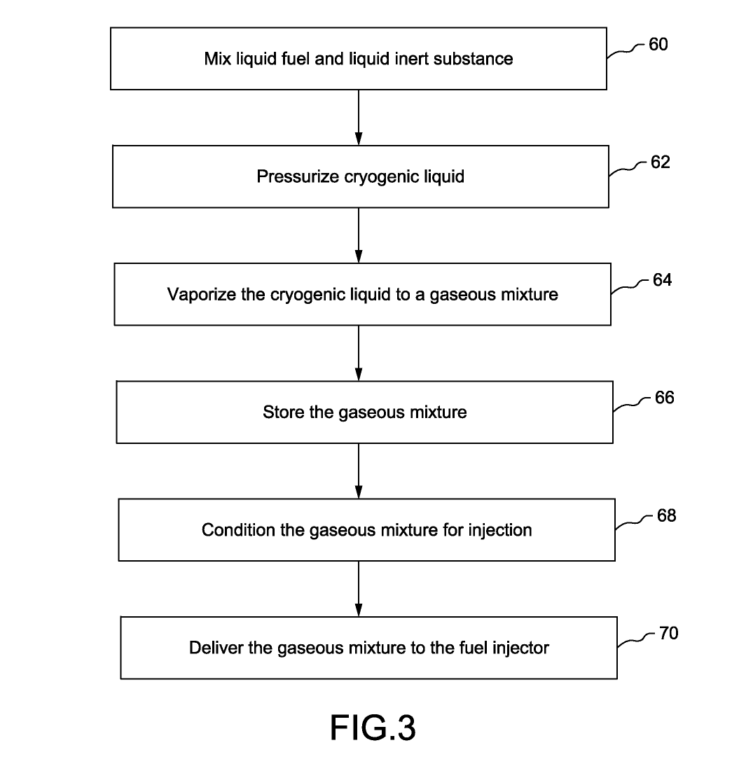

Referring now to FIG. 3, a series of steps that may be involved in delivering the gaseous fuel/inert substance mixture to the engine 22 using the fuel delivery system 24 is shown. Beginning with a block 60, the liquid fuel and the liquid inert substance may be mixed in the desired proportions in the cryogenic storage tank 26 to provide the cryogenic liquid. Alternatively, the liquid fuel and the liquid inert substance may be stored in separate cryogenic tanks and later mixed in the desired proportions using an appropriate mixing device. According to a next block 62, the cryogenic liquid may be pressurized using the cryogenic pump 30 to a high pressure suitable for high pressure direct injection, such as between about 6000 psi and about 7000 psi. The pressurized cryogenic liquid may then be vaporized in the vaporizer 36 to a gaseous mixture (block 64), and the gaseous mixture may be stored in the accumulator 40 (block 66). Optionally, the gaseous mixture may then be conditioned to a fixed pressure or pressure range in the fuel conditioning module 44 according to a next block 68. Lastly, the fuel conditioning module 44 (or the accumulator 40) may deliver the gaseous mixture to the fuel injector 48 according to a next block 70.

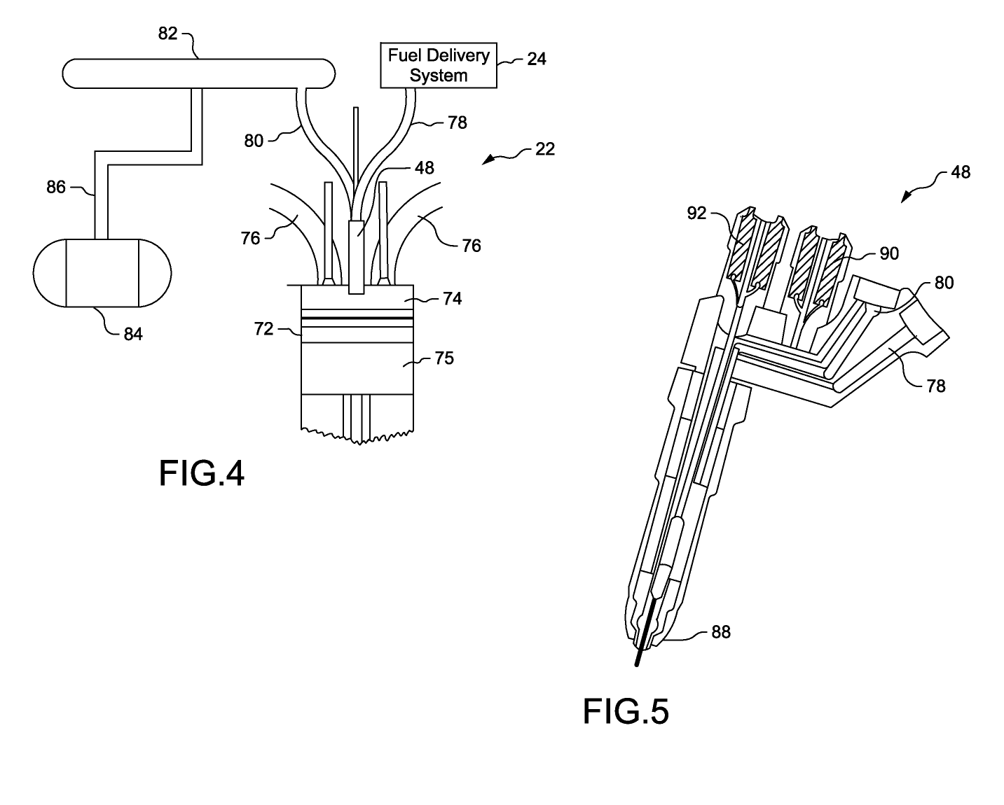

The engine 22 and the fuel injector 48 are shown in greater detail in FIG. 4. The engine 22 may include one or more cylinders 72 each having a combustion chamber 74 disposed therein. Furthermore, the engine 22 may have a piston 75 positioned for displacement within the cylinder 72, as well as one or more exhaust ports 76 to carry combustion products out of the combustion chamber 74 to an exhaust pipe. The fuel injector 48 may be mounted on top of the cylinder 72, as shown, or elsewhere on the cylinder 72. The fuel injector 48 may be a dual fuel injector configured to inject controlled amounts of two different types of fuel into the combustion chamber 74 via two separate passages (a first passage 78 and a second passage 80). Specifically, the fuel injector 48 may be configured to inject the gaseous mixture containing the cryogenic fuel through the first passage 78, and diesel fuel through the second passage 80. The cryogenic fuel may serve as the primary fuel source that provides the majority of or all of the power to the engine, and the diesel fuel may serve as an ignition source for the cryogenic fuel (see further details below). The gaseous mixture containing the cryogenic fuel may be supplied to the first passage 78 of the fuel injector 48 from the fuel delivery system 24, as described in detail above. The diesel fuel may be supplied to the second passage 80 from a common rail 82 that receives the diesel fuel from a fuel source 84 via a fuel path 86.

The fuel injector 48 is shown in greater detail in FIG. 5. The first passage 78 may carry the gaseous mixture containing the cryogenic fuel to an injection nozzle 88 for delivery into the combustion chamber 74, while the second passage 80 may carry the diesel fuel to the injection nozzle 88 for delivery into the combustion chamber 74. In addition, the fuel injector 48 may also include a first valve 90 configured to regulate the flow of the gaseous mixture in the first passage 78, as well as a second valve 92 configured to regulate the flow of diesel fuel in the second passage 80.

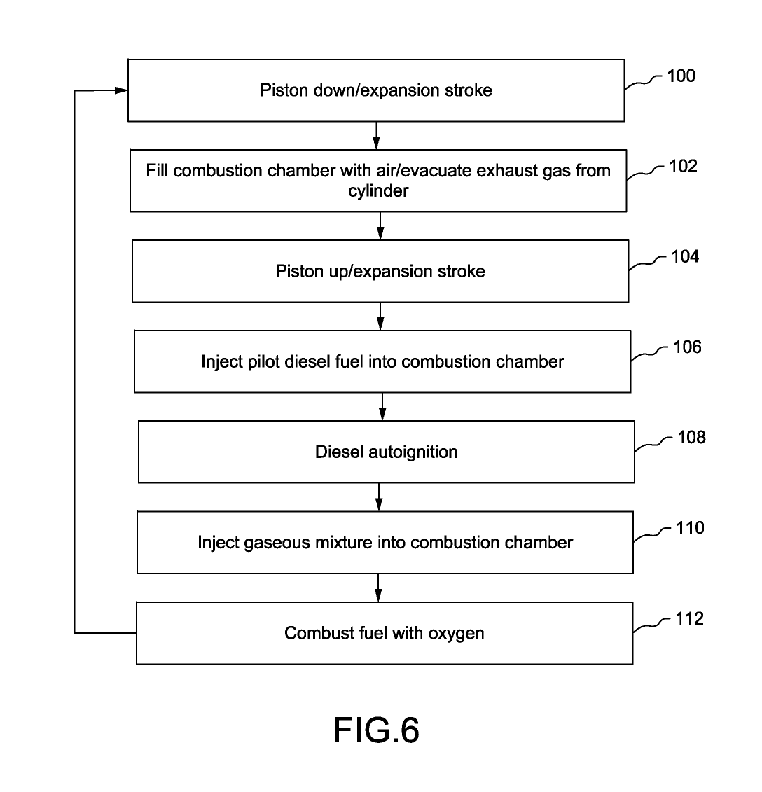

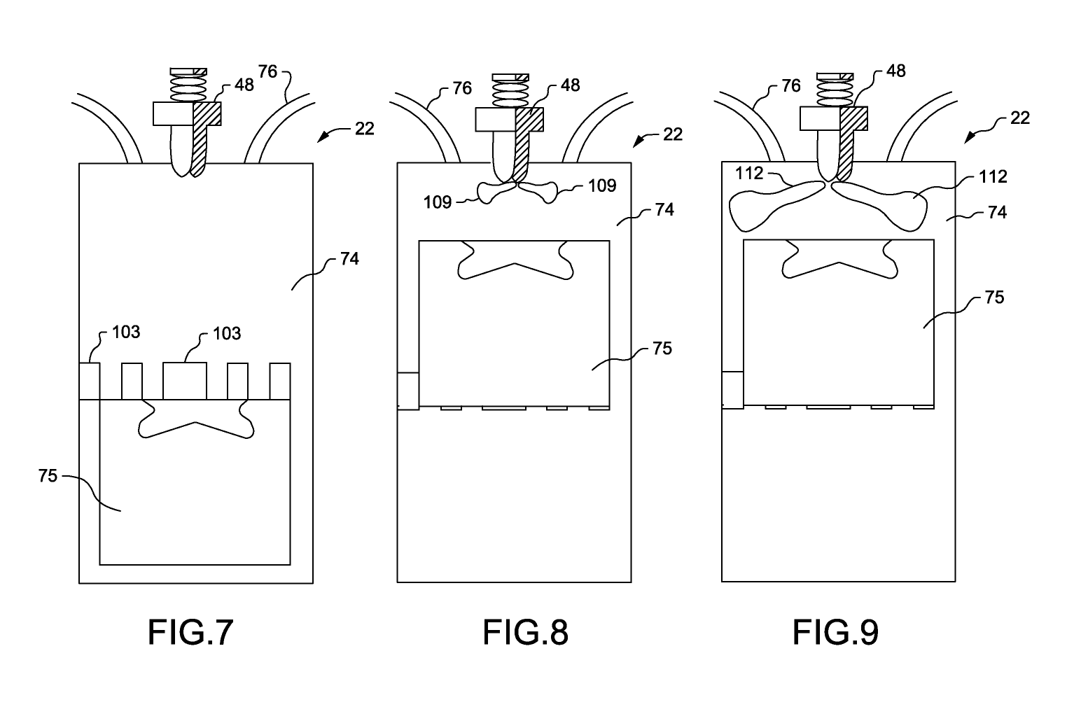

Turning now to FIGS. 6-9, a series of steps involved in a combustion cycle of the engine 22 is shown. The following description is based on a two-stroke engine in which one combustion cycle occurs with every two strokes of the piston 75, although it will be understood that the concepts described below may be adapted for a four-stroke or a six-stroke engine as well. Beginning with blocks 100 and 102, the piston 75 may move down in an expansion stroke allowing a charge of fresh air to enter and fill the combustion chamber 74 through one or more air intake ports 103 (FIG. 7). For example, a turbocharger may push the fresh air into the air intake ports 103, and the pressure of the fresh air in the combustion chamber 74 may push the combustion gas products from the previous combustion cycle out of the combustion chamber 74 through the exhaust port(s) 76, causing the combustion gas products to evacuate the combustion chamber 74. According to a next block 104, the piston 75 may move up to compress and pressurize the air in the combustion chamber 74 in a compression stroke (see FIG. 8), causing an increase in temperature in the combustion chamber 74. In a next block 106, the fuel injector 48 may inject a pilot amount of diesel fuel into the combustion chamber 74, causing the diesel fuel to autoignite (block 108) and create one or more flames 109 that combust as quickly as oxygen can diffuse into the flames 109 in a diffusion combustion process (see FIG. 8).

According to a next block 110, the fuel injector 48 may inject the gaseous mixture of the cryogenic fuel and the inert substance into the combustion chamber 74. The fuel in the gaseous mixture may then begin to combust with oxygen as it is injected into the combustion chamber 74 due to the high temperature of the diesel flame 109 (block 114). The injected fuel may create a combustion plume 112 that combusts by a diffusion combustion process in which the combustion rate is proportional to the rate at which oxygen can diffuse into the plume 112 (see FIG. 9). As the fuel is diluted with the inert substance, the inert substance may lower the local concentration of oxygen in the plume 112 by slowing the rate of oxygen diffusion therein, thereby reducing the combustion rate and the combustion temperature. Thus, the reduced combustion rate/temperature in the combustion chamber 74 when using the diluted fuel may lead to significant reductions in the production of NOₓ in the combustion chamber 74 compared with pure/undiluted fuel. The percentage of the inert substance in the fuel may be adjusted such that the combustion temperature is below about 2200° F. If nitrogen is used as the inert substance, combustion temperatures below about 2200° F. may be achieved with about 10 mass % or more of nitrogen gas in the fuel.

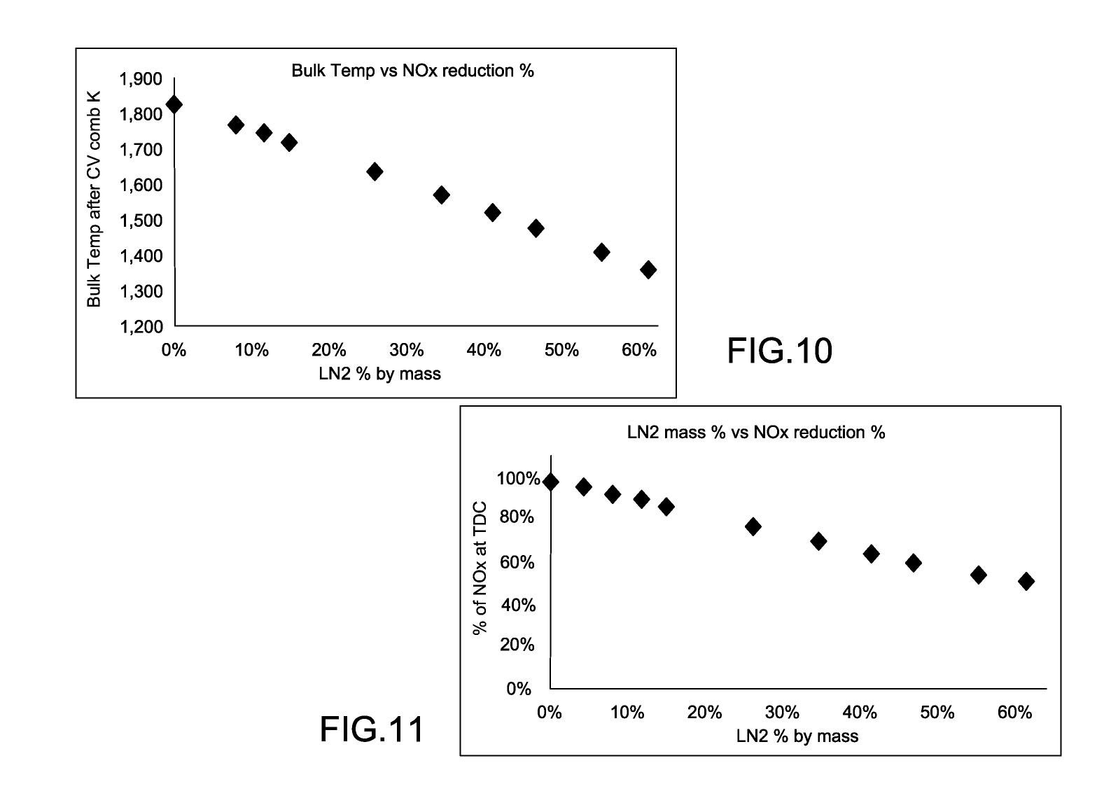

FIGS. 9-10 show the results of theoretical calculations of the effect of varying mass percentages of liquid nitrogen (LN₂) in liquid natural gas on combustion chamber temperatures and the production of NOₓ in a model internal combustion engine. FIG. 10 shows a linear decrease in bulk temperatures in the combustion chamber after constant volume (CV) combustion with increasing mass percentages of LN₂ in the liquid natural gas. Furthermore, FIG. 11 shows a linear decrease in NOₓ production when the piston is at top dead center (TDC) with increasing mass percentages of LN₂. The calculations suggest that significant reductions in NOₓ production in practice may occur as little as 10 mass % of LN₂ in the liquid natural gas.

### INDUSTRIAL APPLICABILITY

The teachings of the present disclosure may find industrial applicability in a variety of settings such as, but not limited to, internal combustion engines with improved NOₓ emission characteristics. The technology disclosed herein dilutes a cryogenic fuel, such as natural gas or methane, with a substance that is inert to combustion, such as nitrogen gas. The inert substance acts to reduce the diffusion rate of oxygen molecules into the fuel combustion flame, thereby lowering combustion rates and temperatures. As the production of NOₓ is proportional to the combustion rate and temperature, the reduced combustion rates and temperatures with the diluted fuel may lead to favorable reductions in NOₓ emissions. For example, applicants have shown steady reductions in combustion temperatures and NOₓ production with increasing liquid nitrogen (LN₂) mass percentages in liquid natural gas fuel, indicating that the percentage of the inert substance in the fuel may be adjusted to tune the NOₓ emission characteristics of the engine to a desired level. In addition, as disclosed herein, the mixture of the fuel and the inert substance may be stored as a cryogenic liquid prior to injection into the combustion chamber to facilitate pressurization of the cryogenic liquid to pressures suitable for high pressure direct injection. The cryogenic liquid may then be vaporized to a gaseous mixture of the fuel and the inert substance prior to high pressure direct injection into the combustion chamber. Notably, the fuel dilution strategy disclosed herein may be implemented in existing engine platforms without large architectural changes to the engine as is often required with NOₓ reduction systems of the prior art, such as EGR systems and SCR aftertreatment systems. Thus, the fuel dilution system disclosed herein may be incorporated into existing engine platforms in an effort to meet increasingly rigid NOₓ emission standards. In some cases, the geometry of the piston bowl and/or fuel injector nozzle may be redesigned to accommodate low NOₓ mixtures in the combustion chamber. It is expected that the technology disclosed herein may find wide industrial applicability in a wide range of areas such as, but not limited to, locomotive, marine, and industrial applications.

What is claimed is:

1. An engine, comprising:
at least one cylinder having a combustion chamber disposed therein;
a piston positioned for displacement within the cylinder;
at least one air intake port configured to allow an intake of air into the combustion chamber; and
a fuel injector configured to inject a fuel diluted with an inert substance into the combustion chamber for combustion with the air, the combustion with the air occurring at a lower temperature than a combustion of the fuel with the air when the fuel is undiluted.

2. The engine of claim 1, wherein the engine is a high pressure direct inject engine.

3. The engine of claim 2, further comprising a fuel delivery system configured to deliver the fuel diluted with the inert substance to the fuel injector, the fuel delivery system including:
a cryogenic storage tank configured to store the fuel and the inert substance as a cryogenic liquid;
a cryogenic pump configured to pressurize the cryogenic liquid from the cryogenic storage tank to a pressurized cryogenic liquid; and
a vaporizer configured to vaporize the pressurized cryogenic liquid from the cryogenic pump to a gaseous mixture of the fuel and the inert substance prior to delivery to the fuel injector.

4. The engine of claim 3, wherein the cryogenic pump is configured to pressurize the cryogenic liquid to a pressure of at least about 6000 psi or more.

5. The engine of claim 3, wherein the fuel injector is a dual fuel injector and is further configured to inject a diesel fuel into the combustion chamber prior to injection of the gaseous mixture, the diesel fuel producing a flame upon injection into the combustion chamber, the flame initiating the combustion of the fuel in the gaseous mixture.

6. The engine of claim 5, wherein the fuel is liquid natural gas.

7. The engine of claim 6, wherein the inert substance is nitrogen gas, and wherein the cryogenic liquid consists of a mixture of liquid natural gas and liquid nitrogen.

8. The engine of claim 7, wherein the cryogenic storage tank includes separate cryogenic storage tanks for each of the liquid natural gas and the liquid nitrogen, and wherein the liquid natural gas and the liquid nitrogen are mixed prior to delivery to the cryogenic pump.

9. The engine of claim 7, wherein the fuel is diluted with between about 2 mass % to about 30 mass % of the inert substance.

10. A locomotive, comprising:
a car body;
one or more trucks supporting the car body and having wheels configured to engage a track; and
an engine including
at least one cylinder having a combustion chamber disposed therein,
a piston positioned for displacement within the cylinder,
at least one air intake port configured to allow an intake of air into the combustion chamber, and
a fuel injector configured to inject a fuel diluted with an inert substance into the combustion chamber for combustion with the air, the combustion with the air occurring at a temperature below about 2200° F.

11. The locomotive of claim 10, wherein the engine is a high pressure direct inject engine.

12. The locomotive of claim 11, further comprising a fuel delivery system configured to deliver the fuel diluted with the inert substance to the fuel injector, the fuel delivery system including:
a cryogenic storage tank configured to store the fuel and the inert substance as a cryogenic liquid;
a cryogenic pump configured to pressurize the cryogenic liquid from the cryogenic storage tank to a pressurized cryogenic liquid; and
a vaporizer configured to vaporize the pressurized cryogenic liquid from the cryogenic pump to a gaseous mixture of the fuel and the inert substance prior to delivery to the fuel injector.

13. The locomotive of claim 12, wherein the cryogenic pump is configured to pressurize the cryogenic liquid to a pressure of at least about 6000 psi or more.

14. The locomotive of claim 12, wherein the fuel injector is a dual fuel injector and is further configured to inject a diesel fuel into the combustion chamber prior to injection of the gaseous mixture, the diesel fuel producing a flame upon injection into the combustion chamber, the flame initiating the combustion of the fuel in the gaseous mixture with the air.

15. The locomotive of claim 14, wherein the fuel is liquid natural gas.

16. The locomotive of claim 15, wherein the inert substance in nitrogen gas, and wherein the cryogenic liquid consists of a mixture of liquid natural gas and liquid nitrogen.

17. The locomotive of claim 16, wherein the cryogenic storage tank includes separate cryogenic storage tanks for each of the liquid natural gas and the liquid nitrogen, and wherein the liquid natural gas and the liquid nitrogen are mixed prior to delivery to the cryogenic pump.

18. The locomotive of claim 16, wherein the fuel is diluted with between about 2 mass % to about 30 mass % of the inert substance.

19. The locomotive of claim 18, wherein the fuel is diluted with about 10 mass % or more of the inert substance.

20. A method for combusting natural gas with air in an engine, the engine including a combustion chamber and a fuel injector, the method comprising:
filling the combustion chamber with the air;
compressing the air in the combustion chamber;
injecting the natural gas diluted with an inert substance into the combustion chamber with the fuel injector; and
combusting the natural gas with the air in the combustion chamber such that the combustion occurs at a lower temperature than a combustion of the natural gas with the air when the natural gas is undiluted.
